(19) United States
(12) Patent Application Publication
(10) Pub. No.: US 2006/0098747 A1
(43) Pub. Date: May 11, 2006

(54) Coded OFDM system and method with improved PAPR reduction

(75) Inventors: Guosen Yue, Plainsboro, NJ (US); Xiaodong Wang, New York, NY (US); Mohammad Madihian, Plainsboro, NJ (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 10/984,177

(22) Filed: Nov. 9, 2004

(51) Int. Cl. H04K 1/10

(52) U.S. Cl. 375/260

(57) ABSTRACT

A system and method is herein disclosed for reducing peak-to-average power ratio in an orthogonal frequency division multiplexing system which utilizes label bits inserted at predetermined locations of an information stream prior to encoding.

### BACKGROUND OF THE INVENTION

The present invention is related to orthogonal frequency division multiplexing and, more particularly, to mechanisms for reducing peak-to-average power ratio in an orthogonal frequency division multiplexing system.

Orthogonal frequency division multiplexing (OFDM) has drawn great interest for its robustness against multipath frequency selective channels. OFDM, otherwise known in the art as multicarrier modulation, has a major drawback in that an OFDM signal has a high peak-to-average power ratio (PAPR) which can disadvantageously require a linear amplifier with a large dynamic range. A number of approaches have been proposed to suppress the peak powers. One technique is to use block coding and other coding techniques to transmit the codewords with lower PAPR. Although providing good performance, such coding techniques introduce design difficulties as the number of subcarriers increase. Another approach is to use what are referred to in the art as “clipping” schemes which, while providing attractive PAPR reduction, often introduce other performance problems such as in-band clipping noise.

Phase rotation is another approach to reducing PAPR. For example, the selective mapping (SLM) technique first rotates the phases of a modulated symbol sequence and then transmits the OFDM signal with the lowest PAPR after an inverse discrete Fourier transform (IDFT). See R. Bauml, R. Fischer, and J. Huber, “Reducing the Peak-to-Average Power Ratio of Multicarrier Modulation by Selected Mapping,” Electron. Lett., Vol. 32, No. 22, pp. 2056-57 (October 1996). The index of the phase rotation sequence is also transmitted to the receiver as side information. A disadvantage of these phase rotation schemes is that the corruption of this side information transmission can cause severe performance loss on the information detection. Recently, selective mapping designs have been proposed that avoid the use of explicit side information. See N. Carson and T. A. Gulliver, “PAPR Reduction of OFDM Using Selective Mapping, Modified R A Codes and Clipping,” in Proc. IEEE Veh. Technol. Conf (VTC), Vancouver, Canada (September 2002); M. Breiling, S. H. Muller-Weinfurtner, and J. B. Huber, “SLM Peak-Power Reduction Without Explicit Side Information,” IEEE Commun. Lett., Vol. 5, No. 6, pp. 239-41 (June 2001). In one proposed design, a linear-feedback shift register (LFSR) is used as a scrambler to transform the data before it is mapped to the orthogonal channels. In another proposed design, the LSFR is recognized to be a rate one convolution encoder, so a modified repeat-accumulate code can be formed by preprocessing a rate one half repeat code and interleaver.

There is a need for a more flexible and simplified mechanism for reducing peak-to-average power ratio in an orthogonal frequency division multiplexing system.

### SUMMARY OF INVENTION

A system and method is herein disclosed for reducing peak-to-average power ratio in an orthogonal frequency division multiplexing system which advantageously is independent of encoder/decoder structure while avoiding the use of explicit side information. In accordance with an aspect of the invention, label bits are inserted at predetermined locations of an information stream prior to encoding. When the coded bits are transformed into an orthogonal frequency division multiplexing signal, the peak-to-average power ratio of the orthogonal frequency division multiplexing signal can be varied by changing the inserted label bits. This technique takes advantage of the properties of recent coding techniques, such as turbo codes, low density parity check codes, and repeat accumulate codes. If a systematic code is utilized, it can be advantageous to utilize an interleaver after encoding. A transmitter can use a label inserter to generate a plurality of candidate streams which, after encoding and transformation, creates a plurality of different orthogonal frequency division multiplexing signals with different peak-to-average power ratios. A selector can then be utilized to choose a signal with a lowest peak-to-average power ratio. A soft amplitude limiter can be combined with the present technique to further suppress the peak-to-average power ratio with little performance sacrifice.

The present invention advantageously does not require side information to be transmitted. A receiver can readily recover the original information bits, after decoding, by stripping the label bits which are located at the predetermined locations of the stream. Since the encoder is separate from the mechanism for suppressing the peak-to-average power ratio, the present invention advantageously should not affect code optimization. Moreover, the present invention may be readily implemented in multiple-input multiple-output systems.

These and other advantages of the invention will be apparent to those of ordinary skill in the art by reference to the following detailed description and the accompanying drawings.

### BRIEF DESCRIPTION OF DRAWINGS

FIG. 1 is an abstract block diagram showing the components of a transmitter, in accordance with an embodiment of the invention.

FIG. 2 is an abstract block diagram showing the components of a receiver, in accordance with an embodiment of the invention.

FIG. 3 is an abstract block diagram showing the components of an IRA encoder utilized in the context of the transmitter depicted in FIG. 1.

FIG. 4 is abstract block diagram showing the components of a transmitter, in accordance with another embodiment of the invention.

### DETAILED DESCRIPTION

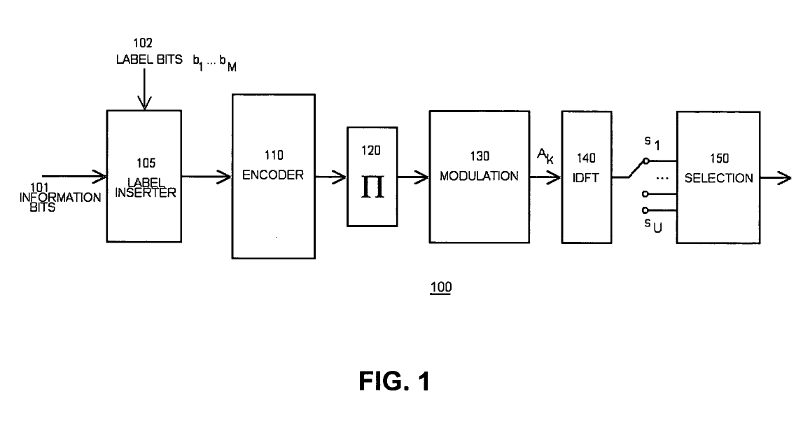

FIG. 1 is an abstract block diagram showing the components of an orthogonal frequency division multiplexing (OFDM) transmitter 100, in accordance with an embodiment of the invention. As depicted in FIG. 1, a block of L information bits 101 in an information stream are first provided to a label inserter 105. The label inserter 105 inserts M label bits 102 at predetermined locations within the information block. The label bits 102 advantageously can be fixed at any place in the information stream arbitrarily. The label bits 102 can be placed far away from each other—or they can be put together at the head of an information block, e.g., concatenated or combined in any other arbitrary fashion. The bits need not be mixed. All that is required is that the label inserter 105 insert the label bits 102 into the information stream in a manner that is known to the receiver.

The combined bits are then encoded by a channel encoder 110 at a rate R=(L+M)/N. As further discussed below, the present invention is not limited to a specific encoding structure, although encoders having “random-like” properties are particularly advantageous. If the code is systematic, it is also advantageous to add an interleaver 120 to further mix the information bits and the parity bits in a random way. For non-systematic codes, such an additional interleaver should not be required. A complex baseband OFDM signal is created, typically by mapping the coded bits into QAM symbols at 130 and then applying an inverse discrete Fourier transform (IDFT) at 140. The N coded bits are modulated using a QAM constellation into a block of K=N/M_{C} symbols Xₖ, k=0, . . . , K−1 assigned to K subcarriers, where M_{C} is the log₂{constellation size}. The modulated symbols are then sent to the inverse Fourier transformer with oversampling. After the IDFT, the resulting discrete complex baseband OFDM signals considering J times oversampling are given by:

$$s ( n ) = \frac{1}{\sqrt{K}} {\sum }_{k = 0}^{K} {X}_{k} {ⅇ}^{j 2 π kn / JK} , \qquad n = 0 , … , JK - 1$$

Note that the cyclic prefix for alleviation of the intersymbol interference is not considered for brevity. The peak-to-average power ratio (PAPR) of the OFDM signal is

$$PAPR = \frac{max {\vert s ( n ) \vert}^{2}}{\frac{1}{JK} {\sum }_{n = 0}^{JK - 1} {\vert s ( n ) \vert}^{2}}$$

The PAPR of the output signal sequence can be measured. By changing the inserted label bits before encoding, different candidate output signal sequences s₁, . . . s_{U} can be obtained with different PAPR. A selector 150 can then select the one candidate OFDM signal with the lowest PAPR to transmit. For example, consider U candidate sequences where U=2^{M} for the above M label bits. Denote F(Y) as the cumulative density function (CDF) of the OFDM discrete signal s(n), assuming s(n) is independent and identically distributed (i.i.d.) and where Y is a given value of PAPR₀. With order statistics, the close expressions of complementary cumulative density function (CCDF) of PAPR using the above mechanism is given by:
Pr(PAPR_{SELECTED}>Y)=(Pr(PAPR>Y))^{U}
where Pr(PAPR>Y)=1−(1−F(Y))^{K}.
Assuming s(n) is complex Gaussian distributed with unit variance, the complementary cumulative density function of the selected OFDM signal is given by:
Pr(PAPR_{SELECTED}>Y)=(1−(1−e^{-Y})^{K})^{U}

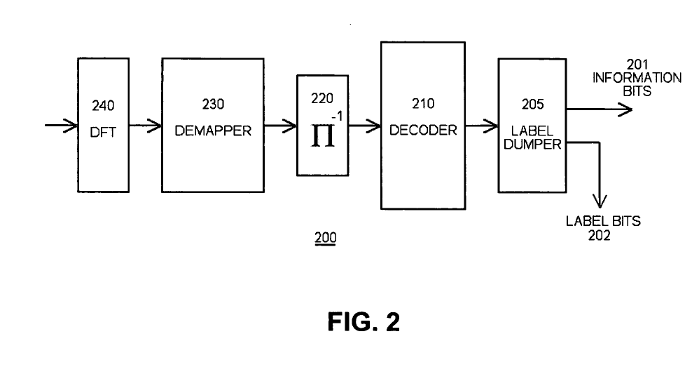

FIG. 2 is an abstract block diagram showing the components of a corresponding receiver 200. The received OFDM signal is passed through a discrete Fourier transform (DFT) at 240 and demodulated at 230. If an interleaver was utilized in the transmitter, in accordance with the discussion above, a corresponding de-interleaver 220 is applied as depicted in FIG. 2. The signal is then decoded at 210. The decoded signal is provided to a label dumper 205 which strips the label bits 202 from the decoded signal, thereby recovering the original information bits 201. The receiver 200 advantageously needs no side information to recover the original signal and, accordingly, should not experience any performance loss due to detection error of side information. Since the label bits were inserted before the encoder, the receiver 200 need only know the predetermined locations where the label bits 202 were inserted into the information block.

The overhead of the PAPR suppression scheme is the ratio of the number of label bits over the information block length, i.e., M/L. The inventors have found that an overhead quantity of only several percent is sufficient to provide significant PAPR reduction.

Although the present invention is not dependent upon a specific encoding structure, it is preferable to utilize an encoder with “random-like” properties, e.g., turbo codes, low density parity check (LDPC) codes, and repeat accumulate (RA) codes. The random-like codes offer capacity achieving performance mostly due to the random interleaving in the codes. Because of the recursive convolutional code in turbo codes and RA codes, or the dense generator matrix in the LDPC code, each bit in the stream can affect almost all of the coded bits for non-systematic codes or N(1−R) parity bits in the systematic coded bits. The non-systematic codes should have better scrambling effect by changing the label bits. The systematic codes still offer good randomization by employing the above-mentioned interleaver before the modulation if the codes rate R is equal to or less than ½.

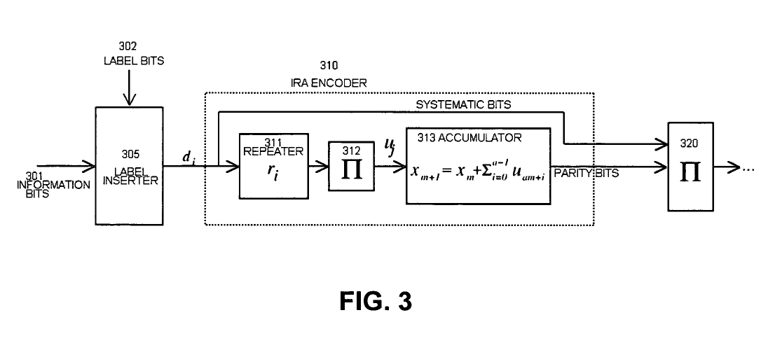

For example, FIG. 3 shows a portion of the transmitter structure of FIG. 1 utilizing an irregular repeat accumulate (IRA) encoder 310. Although the performance of an IRA encoder is generally seen as slightly inferior to LDPC codes, an IRA encoder has an extremely simple encoder structure, which is particularly advantageous when implemented in parallel for different label bits. As depicted in FIG. 3, label bits 302 are inserted by the label inserter 305 into a block of information bits 301. The block of combined bits, {dᵢ} are encoded by an irregular repeat code with dᵢ repeated rᵢ times at 311, where {rᵢ: 2≦rᵢ≦D} are the repetition degrees of {dᵢ}, D being the maximum repetition degree. The repeated bits are interleaved at 312 to obtain {uⱼ}, and then encoded at 313 by an accumulator where xₘ represents parity nodes with an initial setting of x₀=0; a is the grouping factor, and m=0, . . . , M−1. The length of the parity bits is M=n/a where

$$n = {\sum }_{i = k}^{L} {r}_{i} .$$

The final coded bits {bᵢ}ᵢ₌₁^{N} are the collection of the information bits {dᵢ}ᵢ₌₁^{L} and the parity bits

$${\{ {x}_{m} \}}_{m = 1}^{N - L} .$$

An algorithm such as the belief-propagation (BP) message-passing decoding algorithm can be utilized to decode the IRA code.

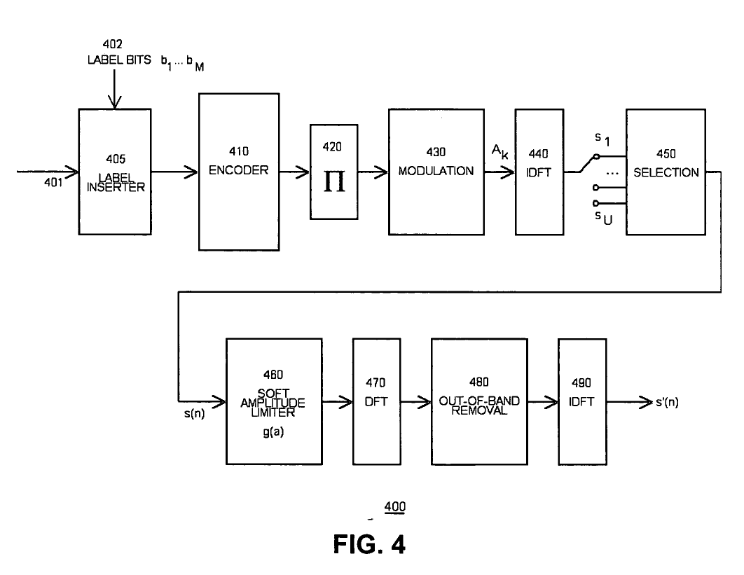

One of the advantages of the present invention is that it can be utilized in conjunction with existing PAPR reduction schemes. For example, FIG. 4 shows how the structure depicted in FIG. 1 can be serially concatenated with a soft amplitude limiter (SAL). As described above, a block of information bits 401 is provided to the label inserter 305 which inserts label bits 402 at predetermined locations within the information block. The combined bits are, if necessary, interleaved at 420 and are then modulated 430 and passed through an IDFT 440 to create one of a plurality of candidate OFDM signals. The selector 450 then chooses the candidate OFDM signal with the lowest PAPR. The selected OFDM signal s(n), as depicted in FIG. 4, then passes through a limiter 460. A DFT is applied at 470 so as to allow the performance of out-of-band distortion removal at 480. Then, an IDFT 490 is reapplied, and the clipped signal s'(n) is transmitted. The out-of-band removal and the IDFT can be simply implemented by the K-point IDFT to the JK-point signal output from the DFT. It can be shown that the combined techniques can potentially offer better performance than simple clipping.

The present invention advantageously can be directly applied to multiple-input multiple-output (MIMO) OFDM systems. The above-described PAPR suppression scheme can be employed at each antenna in a similar manner as in the single antenna system. In a MIMO OFDM system, the coded bits would be first mapped to QAM constellations and then divided into nT streams. The nT stream symbols would be sent to an IDFT and then sent to nT transmit antennas. The PAPR of the OFDM signals with the multiple transmit antennas can be defined as

$$PAPR = {max}_{n} ( {PAPR}_{n} ) , \qquad n = 1 , … , {n}_{T}$$

where PAPRₙ denotes the PAPR of the nth transmit antenna in the MIMO-OFDM system. As in the single antenna example, label bits can be inserted and varied in predetermined locations in an information block and the OFDM signals selected so as to minimize the overall PAPR of the MIMO-OFDM system.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents. As but one of many variations, it should be understood that encoder/decoders other than the ones described above can be readily utilized in the context of the present invention.

What is claimed is:

1. A method of reducing peak-to-average power ratio in an orthogonal frequency division multiplexing system comprising:
receiving a stream of information bits;
inserting label bits into predetermined locations of the stream of information bits to create a combined stream of information and label bits; and
encoding the combined stream of information and label bits with an encoder, thereby creating a series of coded bits that can be transformed into an orthogonal frequency division multiplexing signal whose peak-to-average power ratio can be varied by changing the inserted label bits.

2. The method of claim 1 wherein the encoder uses a systematic code and wherein the series of coded bits is interleaved after encoding.

3. The method of claim 1 wherein the encoder uses a non-systematic code.

4. The method of claim 1 wherein the encoder uses one of turbo codes, low density parity check codes, and repeat accumulate codes.

5. The method of claim 1 wherein the step of inserting the label bits into predetermined locations of the stream comprises concatenating the label bits and the information bits.

6. The method of claim 1 wherein the step of inserting the label bits into predetermined locations of the stream comprises mixing the label bits and the information bits.

7. The method of claim 1 wherein the orthogonal frequency division multiplexing system is a multiple-input multiple-output system.

8. A transmitter for an orthogonal frequency division multiplexing system comprising:
a label inserter which receives a stream of information bits and creates a plurality of candidate streams by inserting different label bits into predetermined locations in the stream of information bits;
an encoder which encodes the plurality of candidate streams to create encoded bits which can be transformed into a plurality of candidate orthogonal frequency division multiplexing signals; and
a selector which receives the plurality of candidate orthogonal frequency division multiplexing signals and selects for transmission a candidate orthogonal frequency division multiplexing signal from the plurality of orthogonal frequency division multiplexing signals with a lowest peak-to-average power.

9. The transmitter of claim 8 further comprising an interleaver which interleaves the encoded bits prior to transformation into candidate orthogonal frequency division multiplexing signals and wherein the encoder uses a systematic code.

10. The transmitter of claim 8 wherein the encoder uses a non-systematic code.

11. The transmitter of claim 8 wherein the encoder uses one of turbo codes, low density parity check codes, and repeat accumulate codes.

12. The transmitter of claim 8 further comprising a soft amplitude limiter for further reduction of peak-to-average power.

13. The transmitter of claim 8 wherein the orthogonal frequency division multiplexing system is a multiple-input multiple-output system.

14. A receiver for an orthogonal frequency division multiplexing system comprising:
a decoder which receives a transformed orthogonal frequency division multiplexing signal and decodes the transformed signal into a stream of information bits and label bits, the label bits inserted so as to vary the peak-to-average power ratio of the orthogonal frequency division multiplexing signal; and
a label dumper which receives the stream of information bits and label bits and which strips the label bits located at predetermined locations of the stream.

15. The receiver of claim 14 further comprising a de-interleaver which de-interleaves the transformed orthogonal frequency division multiplexing signal before decoding wherein the decoder uses a systematic code.

16. The receiver of claim 14 wherein the decoder uses a non-systematic code.

17. The receiver of claim 14 wherein the decoder uses one of turbo codes, low density parity check codes, and repeat accumulate codes.

18. The receiver of claim 14 wherein the orthogonal frequency division multiplexing system is a multiple-input multiple-output system.

19. A method of reducing peak-to-average power ratio in an orthogonal frequency division multiplexing system comprising:
receiving an orthogonal frequency division multiplexing signal;
transforming the orthogonal frequency division multiplexing signal into a stream of coded bits and decoding the stream of coded bits into a combined stream of information bits and label bits, the label bits inserted by a transmitter so as to vary the peak-to-average power ratio of the orthogonal frequency division multiplexing signal; and
stripping the label bits located at predetermined locations of the combined stream so as to recover a stream of the information bits without the label bits.

20. The method of claim 19 wherein the predetermined locations of the label bits in the combined stream are at locations such that the label bits are concatenated with the information bits.

21. The method of claim 19 wherein the predetermined locations of the label bits in the combined stream are at locations such that the label bits are mixed with the information bits.

22. The method of claim 19 wherein the orthogonal frequency division multiplexing system is a multiple-input multiple-output system.
